(19) United States
(12) Patent Application Publication
(10) Pub. No.: US 2011/0238573 A1
(43) Pub. Date: Sep. 29, 2011

(54) CARDLESS ATM TRANSACTION METHOD AND SYSTEM

(75) Inventor: Rammohan Varadarajan, Cupertino, CA (US)

(73) Assignee: Computer Associates Think, Inc., Islandia, NY (US)

(21) Appl. No.: 13/048,096

(22) Filed: Mar. 15, 2011

Related U.S. Application Data
(60) Provisional application No. 61/317,400, filed on Mar. 25, 2010.

(51) Int. Cl. G06Q 40/00

(52) U.S. Cl. 705/43

(57) ABSTRACT

A method and system are provided for conducting automatic teller machine (ATM) transactions without the use of an ATM card, using a mobile user device. The mobile user device communicates with an ATM, a provider interface or a network. The ATM communicates with the mobile user device through a contact or contactless means, which may include communication through any wireless connection such as RFID, Bluetooth™ or other near field communication means, or through a USB port or other means of contact. A mobile user device may provide transaction information or authentication information to an ATM or to an authentication system in communication with an ATM. The transaction may be associated with the user's ATM account or another account. The mobile user device may generate a dynamic value which may be used as a password, an authentication value, an account identifier or a transaction identifier.

### CROSS-REFERENCE TO RELATED APPLICATIONS

This application claims the benefit of U.S. Provisional Patent Application No. 61/317,400, filed on Mar. 25, 2010, which is hereby incorporated by reference in its entirety.

### TECHNICAL FIELD

The present application relates to conducting an ATM transaction using a mobile device, and without the use of an ATM card.

### BACKGROUND

Access to Automated Teller Machines (ATMs) has certain security vulnerabilities. To use an ATM, a user must insert an ATM card associated with the user's account into a card reader on the ATM and provide the user's Personal Identification Number (PIN), typically by inputting the PIN through a keypad or touch screen on the ATM. The ATM reads user account information from the magnetic stripe on the ATM card and receives the PIN information through the keypad or touch screen. Information from the magstripe and the PIN are sent over a banking network, eventually reaching the financial institution that holds the account, where the PIN is verified.

Security of the card, the PIN and the ATM interfaces used to receive information from the card and the PIN may be breached by a number of known methods, and end-user security of an ATM card may depend primarily on the user holding and keeping the user's ATM card secure, and keeping the user account PIN secret. The card magstripe can be easily read, for example, using a skimmer attached to the ATM card reader or another card reader such as a merchant point of sale (POS) card reader. The skimmed information may be used to clone or duplicate the card. The PIN may be obtained by visual observation which may be in person or through the use of surveillance equipment such as cameras recording PIN input into a keypad or a touch screen at an ATM terminal.

### SUMMARY

A method and system are provided for conducting an automatic teller machine (ATM) transaction with a provider system, without the use of an ATM card. The system includes an ATM and a network each configured to communicate with a mobile user device and the provider system. The mobile user device is configured to communicate with one or more of the network, the ATM and the provider system, and is configured to receive transaction information related to an ATM transaction between a user of the mobile user device and the provider system. The ATM is configured to receive the transaction information provided to the mobile user device such that the ATM and the provider system can process the ATM transaction when the transaction information is input into the ATM. The ATM may include an ATM interface configured to receive transaction information from and send transaction information to an interface of the mobile user device. The system may be configured such that a transaction identifier is substituted for all or a portion of the transaction information provided to the ATM to conduct the transaction.

A method for conducting an ATM transaction includes inputting transaction information into a mobile user device, establishing a connection between the mobile user device and an ATM, and inputting the transaction information into the ATM via the connection established between the mobile user device and the ATM. The method includes providing the transaction information to a provider system using the ATM and processing the transaction information using the provider system. The method further includes generating and providing a transaction authorization result to the ATM using the provider system, and completing the authorized transaction using the ATM.

The ATM may be configured for communication with the mobile user device through a contact or contactless means, which may include communication through any suitable wireless connection such as RFID, Bluetooth™ or other near field communication means, or through a USB port or other suitable means of contact. The mobile user device may provide transaction information or authentication information to an ATM or to an authentication system in communication with an ATM. The transaction may or may not be associated with a user's ATM account. The mobile user device may also be configured to generate a dynamic value which may be used as one of a password, an authentication value, an account identifier or a transaction identifier.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of an exemplary system in which embodiments of the claimed invention may be implemented;

FIG. 2 is a schematic illustration of a process for performing an ATM transaction using a mobile device in communication with an ATM;

FIG. 3 is a schematic illustration of a process for performing an ATM transaction using a mobile device in communication with an ATM and a provider system; and

FIG. 4 is a schematic illustration of a process for performing a beneficiary transaction using a mobile device in communication with an ATM.

### DETAILED DESCRIPTION

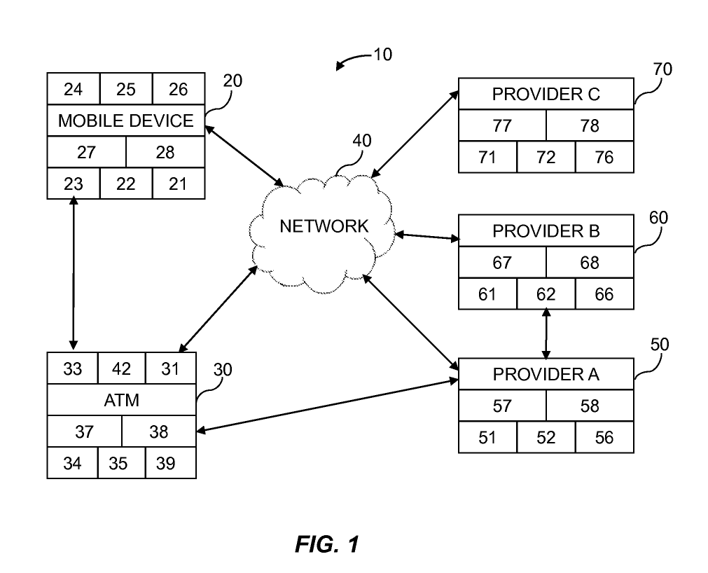

Referring to the drawings wherein like reference numbers correspond to like or similar components throughout the several figures, there is shown in FIG. 1 a schematic illustration of a system 10 for conducting automated teller machine (ATM) transactions using a mobile device in communication with an ATM. The system 10 includes an ATM 30, and a plurality of provider systems 50, 60, 70, which are each configured to communicate with a network 40, which may be, for example, the internet.

The system 10 also includes a mobile user device 20, which may be any of a variety of mobile user phones, personal digital assistants (PDAs) and other handheld or portable devices (iPhone™, Blackberry™, etc.) configured for mobile communications, including communication with network 40. The mobile user device 20 is configured to communicate with the network 40 through an interface 21, which may be a modem, mobile browser, wireless internet browser or similar means suitable for accessing the network 40.

The mobile user device 20 may be further configured with an ATM application 22 and may be configured with a dynamic value generator (DVG) 26. The ATM application 22 on the mobile user device 20 may include one or more algorithms configured to conduct communications with an automated teller machine such as the ATM 30. The DVG 26 may include one or more algorithms configured to generate one or more types of dynamic values, such as one-time passcodes, transaction identifiers and authentication values.

The mobile user device 20 may further include a memory 27 and a central processing unit (CPU) 28. The memory 27 of device 20 can include, by way of example, Read Only Memory (ROM), Random Access Memory (RAM), electrically-erasable programmable read only memory (EEPROM), etc., of a size and speed sufficient for executing one or more algorithms included in the application 22 and/or the DVG 26 and activated on the mobile user device 20.

The mobile user device 20 is configured to provide an output or display 24 configured to display, for example, a menu and related information associated with the ATM application 22 and/or the DVG 26, information input into or received by the device 20 such as information provided through an input interface 25, selected from a display 24 or received by the mobile user device 20. The mobile user device 20 includes an input interface 25 configured to receive input from the user, which may include any or a combination of a keypad, a camera, a retinal scanner, a print pad, an electronic receiver, a display, a touch screen, or other inputs configured to a mobile device.

The mobile user device 20 may also be configured to communicate with an ATM 30 through an interface 23, which may be a wireless or wired interface. The ATM 30 may be configured to communicate with the mobile user device 20 through an interface 33. The device interface 23 and the ATM interface 33 may be configured by any means suitable for communication of transaction and authentication information between the mobile user device 20 and the ATM 30, e.g., the interface 23 and the interface 33 are each configured as an input interface and an output interface, with respect to the other. For example, the interface 23 and the interface 33 may be configured as physical, wired or contact interfaces such as a universal serial bus (USB) or a subscriber identity module (SIM) card interface or other types of wired, cabled or pluggable connections. As another example, the interface 23 and the interface 33 may be configured as a contactless or a wireless interface utilizing any of a number of contactless communication technologies, including but not limited to Bluetooth™, RFID, transponders, proximity card communication techniques, and other methods known to those skilled in the art generally including near field communication technologies.

Still referring to FIG. 1, the ATM 30 may be provided with the interface 33 configured as described previously for communication with the mobile user device 20. As would be appreciated by those skilled in the art, the ATM 30 may require modification from currently known configurations to be configured with an interface 33 as described herein. The ATM 30 may be further configured with an interface 31 which may be a modem, browser or similar means suitable for accessing a network or the internet 40. The interface 31 may be configured to directly communicate with and/or access one or more provider systems, for example, a provider system 50, without accessing the network 40, where the accessible provider system(s) may be a hosting system for the ATM 30 or a provider system associated with the ATM 30.

The ATM 30 may be further configured with a memory 37 and a central processing unit (CPU) 38. The CPU 38 of ATM 30 may be configured by programming to conduct transactions of the types which are or may be processed through an ATM interface, including financial transactions. The memory 37 of the ATM 30 can include, by way of example, Read Only Memory (ROM), Random Access Memory (RAM), electrically-erasable programmable read only memory (EEPROM), etc., of a size and speed sufficient for executing one or more of the applications residing on the CPU 38 of ATM 30.

The ATM 30 is configured to provide at least one output interface or display 34, which may be configured to display, for example, a menu and related information associated with one or more ATM transactions, and is further configured with at least one input which may be configured to receive input from the user, such as a keypad 35, a card reader 39, or a display 34 where the display 34 may be configured for input, for example, through a touch screen. The ATM 30 may be configured to include other input interfaces not shown, such as a camera, a retinal scanner, a print pad, a microphone, or other input devices as would be understood by those skilled in the art. The ATM 30 is configured with other features typical of an ATM, which may include, for example a dispenser 42 for the dispensing of currency (cash), a printer (not shown) to provide printed transaction information and a receiving mechanism (not shown) to input other paper based items such as negotiable documents, checks, bank drafts, money deposits and printed communications.

Still referring to FIG. 1, the system 10 further includes the first provider system 50 corresponding to a first provider A which may be typically a bank or other financial institution engaged in conducting ATM based transactions, and which may also be referred to as the provider A system 50. It would be understood that the first provider A may also provide credit or debit card payment processing or other payment system processing, or may be a merchandiser or service or utility provider which utilizes ATM based transactions to conduct business. The user of the mobile user device 20 may have one or more accounts with provider A and may utilize the ATM 30 to conduct one or more transactions related to the one or more accounts. Alternatively, the user of the mobile user device 20 may not have an account with provider A, however may be the recipient or beneficiary of a transaction provided by or through the provider A system 50.

The provider A system 50 is configured to communicate with the network 40 through a provider A interface 51, for example, the provider A's website, to interface with the ATM 30 through the interface 31 or to interface with the mobile user device 20 through the interface 21. The provider A system 50 may be further configured to communicate with the ATM 30 by directly interfacing with the ATM 30, e.g., through a means other than the network 40, such as through an intranet or other dedicated interface. Further, the provider A system 50 may provide hosting services for the ATM 30, which may include conducting transaction authorization and authentication tasks or processes on behalf of other providers, or providing an interface between the ATM 30 and other provider systems, such as one or more of the systems 60, 70.

The provider A system 50 is configured with a memory 57 and a CPU 58 and may include one or more servers performing various functions. For example, the provider A system 50 may include one or more servers providing at least one of a transaction authorization system 52 and an authentication system 56. The provider A system 50 may be configured by programming to conduct ATM related transactions, which may include conducting transaction authorization and authentication. Additionally, the provider A system 50 may include one or more dynamic value generators to generate, by way of non-limiting example, passcodes and transaction identifiers, which may be one-time values, through the use of algorithms and/or secret keys configured for generating dynamic values. The memory 57 of system 50 may include, by way of example, ROM, RAM, EEPROM, etc., of a size and speed sufficient for conducting transaction authorization and authentication processes or other tasks and processes related to ATM based transactions and for configuring, providing and/or activating algorithm, keys, secrets, and/or dynamic value generators related to conducting ATM based transactions and to the processes, methods and systems described herein. Provider A system 50 may include one or more databases which may include, for example account, transaction, authentication and/or other information related to ATM based transactions, processes and systems as described herein.

The system 10 may further include a second provider system 60 corresponding to a second provider B, which may be, in a non-limiting example, a bank or financial system, a credit/debit card processor, a payment system provider, a merchandiser, a service provider, a utility provider, etc., which may utilize ATM based transactions to conduct business, and which may also be referred to as the provider B system 60. The user of the mobile user device 20 may have one or more accounts with the provider B and may utilize the ATM 30 to conduct transactions related to the one or more accounts. Alternatively, the user of the mobile user device 20 may not have an account with the provider B, however may be the recipient or beneficiary of a transaction provided by or through the provider B system 60.

The provider B system 60 is configured to communicate with the network 40 through a provider B interface 61, for example, the provider B's website, to interface with the ATM 30 through an interface 31 or to interface with the mobile user device 20 through the interface 21. The provider B system 60 may be further configured to communicate with the ATM 30 by interfacing with the ATM 30 through a means other than the network 40, for example, by directly interfacing with the ATM 30 as described for the provider A system 50, or by directly interfacing with an ATM host system, which may be, for example, the provider A system 50.

As described previously for the system 50, the provider B system 60 may be configured with a memory 67 and a CPU 68 and may include one or more servers performing various functions. For example, the provider B system 60 may include one or more servers, which may be configured to provide a transaction authorization system 62 and an authentication system 66. The provider B system 60 may be configured by programming to conduct ATM related transactions, which may, for example, include transaction authorization and authentication processes. Additionally, the provider B system 60 may include one or more dynamic value generators to generate, for example, passcodes and/or transaction identifiers, which may each be provided as one-time values, through the use of one or more algorithms and/or secret keys configured for generating dynamic values. The memory 67 of the system 60 can include, by way of example, ROM, RAM, EEPROM, etc., of a size and speed sufficient for conducting transaction authorization and authentication processes or other tasks and processes related to conducting ATM based transactions and for configuring, providing and/or activating one or more of algorithms, keys, secrets, and/or dynamic value generators related to ATM based transactions and to the processes, methods and systems described herein. The provider B system 60 may include one or more databases which may include account, transaction, authentication and/or other information related to ATM based transactions, processes and systems as described herein.

Still referring to FIG. 1, the system 10 includes at least a third provider system 70 corresponding to a third provider C, which may be, by way of non-limiting example, a bank or financial system, a credit/debit card processor, a payment system provider, a merchandiser, a service provider, a utility provider, etc., which may utilize ATM based transactions to conduct business, and which may also be referred to as the provider C system 70. As described previously, the user of the mobile user device 20 may have one or more accounts with the provider C and may utilize an ATM 30 to conduct transactions related to the one or more accounts. Alternatively, the user of the mobile user device 20 may not have an account with the provider C, however may be the recipient or beneficiary of a transaction provided by or through the provider C system 70.

The provider C system 70 may be configured to communicate with the network 40 through a provider C interface 71, which may be, for example, the provider C's website, to interface with the ATM 30 through an interface 31 or to interface with the mobile user device 20 through the interface 21. The provider C system 70 may be further configured to communicate with the ATM 30 by interfacing with the ATM 30 through a means other than the network 40, for example, by directly interfacing with the ATM 30 as described for the provider A system 50, or by directly interfacing with an ATM host system, which may be, for example, the provider A system 50.

As described previously for the system 50, the provider C system 70 may be configured with a memory 77 and a CPU 78 and may include one or more servers performing various functions. For example, the provider C system 70 may include one or more servers which may be configured to provide a transaction authorization system 72 and/or an authentication system 76. The provider C system 70 may be configured by programming to conduct ATM related transactions, which may include, for example, conducting transaction authorization and authentication. Additionally, the provider C system 70 may include one or more dynamic value generators which each may be configured to generate passcodes and/or transaction identifiers, which may be provided as one-time values, through the use of algorithms and/or secret keys configured for generating dynamic values. The memory 77 of system 70 can include, by way of example, ROM, RAM, EEPROM, etc., of a size and speed sufficient for conducting transaction authorization and authentication processes and/or other tasks and processes related to ATM based transactions and for configuring, providing and/or activating one or more of algorithms, keys, secrets, and/or dynamic value generators related to ATM based transactions and to the processes, methods and systems described herein. The provider C system 70 may include one or more databases including, for example, account, transaction, authentication and/or other information which may be related to the ATM based transactions, processes and systems as described herein.

The system 10 may include additional provider systems and additional ATM machines which may be configured as described previously for the provider systems 50, 60, 70 and ATM 30, respectively, with which the mobile user device 20 may interface to conduct ATM based transactions. The user of the mobile user device 20 may have one or more accounts with a provider and may utilize the ATM 30 or a similarly configured ATM to conduct one or more transactions related to the one or more accounts. Alternatively, the user of the mobile user device 20 may not have an account with any of the providers in system 10, however may be the recipient or beneficiary of a transaction provided by or through one of the providers which may be transacted through the ATM 30 or another ATM within the system 10.

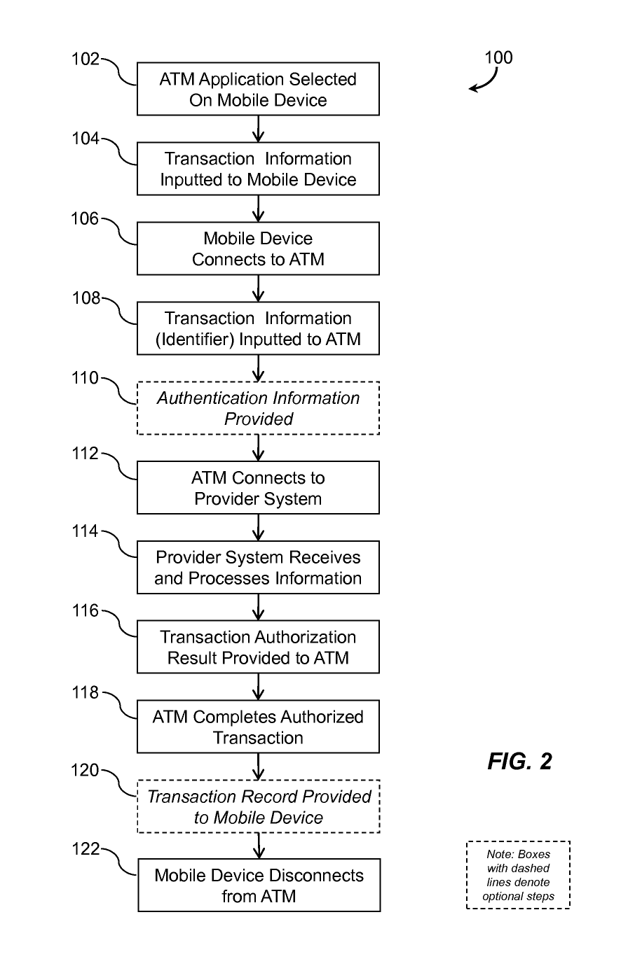

Referring now to FIG. 2, shown generally at 100 is a schematic illustration of a process or method for performing an ATM transaction using a mobile device in communication with an ATM. Referring to FIG. 2 and referencing system 10 of FIG. 1, and beginning with step 102, a user accesses an ATM application 22 on the user's mobile user device 20. The user may have previously been required to download the ATM application 22 to the mobile user device 20 from a provisioning server through the network 40 and a device interface 21, and may have been required to provide, in a non-limiting example, a user name, mobile device information and/or other identifying and authenticating information as needed to activate the ATM application 22 on the user's mobile user device 20.

Additionally, the user may have been required to activate each provider system link and/or each provider account on the ATM application 22 prior to using the ATM application 22 to perform an ATM transaction related to the specific provider or the specific provider account. The user may have activated providers with which the user holds accounts. By way of non-limiting example, the user may activate a link to the provider A, which may be a banking institution, and may activate the user's bank account held with the provider A using the ATM application 22 on the user's mobile user device 20. The user may activate a second provider B, which may be a financial institution, and may activate the user's credit card account held with the provider B, again using the ATM application 22 on the user's mobile user device 20.

Activation of each provider and provider account may require contacting the respective provider's system using the mobile user device 20, through one or more of the interfaces 21, 51, 61 and the network 40, for example, and providing account and authentication information to the provisioning system for each provider. The user may be required to elect options for ATM transactions which are mobile device initiated. For example, the user may be required to elect limitations on transaction types, amounts, geographical or time limitations for transaction authorizations, and may elect security and authentication options. In some cases, the user may be required to download and install a one-time passcode generator or other DVG 26 to provide an authenticating value or transaction identifier. The one-time passcode, authenticating value, transaction identifier or other dynamic value may be generated using one or more of a key, secret and/or other datum which is shared by the provider's authenticating system and the mobile user device 20.

Alternatively or in addition, another key, secret or other datum which is shared by the provider's transaction authorization system and the mobile user device 20 may be downloaded and used in the encryption, camouflaging or obfuscation of information provided by the mobile user device 20 to the provider system through the ATM 30 or through the network 40. The user may be required to provide other information which may be used to authorize or authenticate an ATM transaction, including, for example, mobile device identification information, and/or personal identification information which may include biometric information and/or challenge responses.

At step 104, the user selects a provider and a provider ATM transaction to be completed using the mobile user device 20 and the ATM 30 and inputs the transaction information into the mobile device, using an input interface 25 which may be a keypad or a touch screen of the display 24, or other input as described previously. The transaction information which is required to be inputted and the format and configuration of that information may vary, for example, by the provider, the nature and magnitude of the transaction and according to options selected by the user. The ATM application 22 may prompt the user, through a menu or other prompts, for input of transaction information required for completion of the selected provider transaction. Inputting information may include inputting by any known means, for example and not limited to selecting from a menu on the display 24 of the mobile user device 20, keying information into a keypad 25 or a touch screen, speaking into a speaker, providing data or an electronic signal through a USB port, a SIM card, a card reader, etc., interfacing with the mobile user device 20 using a contact, wired, contactless or wireless input to provide electronic or biometric information, providing biometric information such as a retinal scan or a fingerprint into a device camera or pad reader, or generating a code, a personal identification number (PIN), a one-time passcode (OTP), a digital signature, a key, a secret, a datum, a signal, a machine identifier or other dynamic value using a dynamic value generator 26 or OTP generator and inputting the generated value. The transaction information may include one or more of a provider identifier, a user name or identifier, and account number or identifier, a transaction type, a transaction amount, recipient or beneficiary information including recipient/beneficiary name or identifier, a recipient account number or identifier, and/or other information further identifying, controlling or limiting the transaction, such as a transaction expiration date or time, or selection of a geographic location within which the transaction is authorized, or a combination of these. The transaction information may further include authentication information such as the user account holder's PIN, an OTP, a transaction identifier, challenge or challenge response, digital signature, key, secret, datum, device identifier, biometric value and/or other authentication information or value, or a combination of these.

Inputting the transaction information into the user's mobile user device 20 rather than inputting the transaction information directly into an ATM 30 represents numerous advantages to the user. The user may input the information into the mobile user device 20 in a private or secure location before proceeding to the ATM 30, where the inputted information is not susceptible to observation by another person or means of surveillance. By inputting the transaction information to the user's mobile device rather than into an ATM, the user avoids other security threats including card skimmers attached to the ATM card reader, risk of loss or theft of the user's ATM card, and other forms of interception of information input into the ATM's keypad, card reader or touch screen by surveillance or other known means. Further, as described previously, the transaction information inputted into the user's mobile device may be encrypted, obfuscated or camouflaged with a key or other secret shared with the provider for the transaction, such that the transaction information transmitted from the user's mobile device to the ATM is further secured and protected from interception and attack. The efficiency of the ATM transaction is increased by inputting the information into the user device before proceeding to the ATM, minimizing the time required by the user to complete the transaction at the ATM, which may also improve user convenience, safety and comfort by minimizing user time at the ATM location, especially where the ATM may be situated in an unsecure, inclement, unprotected or uncomfortable location. The user's security and convenience may be further enhanced because the user may select from multiple providers and accounts activated on the ATM application 22 on the mobile user device 20 and thereby complete multiple ATM transactions without having the multiple associated ATM cards present, e.g., in the user's possession. Because the user's account cards (ATM, credit, debit or other transaction cards) need not be in the user's possession to complete an ATM transaction by the method and system described herein, the user can maintain the account cards in a secure location, thus reducing the risk of loss and theft. The user may take additional steps to enhance the security of the mobile user device 20, including, for example, adding locks or passwords to access the mobile user device 20 and/or the ATM application 22.

Continuing with FIG. 2, at step 106, the user connects the mobile user device 20 to the ATM 30, for example, by using the device interface 23 and the ATM interface 33. As described previously, the device interface 23 and the ATM interface 33 may be configured by any means suitable for communication of transaction and authentication information between the mobile user device 20 and the ATM 30, e.g., the interface 23 and the interface 33 may each be configured as an input interface and an output interface, with respect to the other, and may be configured as physical, wired or contact interfaces such as USB or SIM card interfaces or other types of wired, cabled or pluggable connections, or may be configured as contactless or wireless interfaces utilizing any of a number of contactless communication technologies, including but not limited to Bluetooth™, RFID, transponders, proximity card communication techniques, and other methods known to those skilled in the art of near field communication technologies. The user may be required to prompt the connection of the ATM 30 and the mobile user device 20, for example, by selecting a “Connect to Mobile Device to ATM” option from a menu on the ATM 30 and/or the mobile user device 20, or in the case of a wired connection, by physically connecting the device interface 33 into the ATM interface 23, for example, by connecting the respective USBs of the mobile user device 20 and the ATM 30.

At step 108, the transaction information may be communicated from the mobile user device 20 to the ATM 30 through the interfaces 23, 33. In a non-limiting example, the transaction information inputted to the ATM 30 from the mobile user device 20 may include all of the information required to complete the user's ATM transaction, including, for example, authentication information such as the user's account PIN or OTP, thus avoiding the need for the user to input any information into the ATM 30 through the ATM keypad 35, the display touch screen 34, the card reader 39 or any other ATM interface other than the interface 33. The transaction information may be additionally protected from interception attacks which may occur within the ATM system including attacks on the ATM interface 33 by, for example, encrypting, obfuscating, camouflaging or otherwise cryptographically securing the transaction information using a key, and/or secret shared by the user's mobile user device 20 and the provider system of the provider with which the transaction is to be conducted, such that the transaction information, even if susceptible to an interception attack, is not discernible by other than the provider system possessing the shared key.

Alternatively, the provider system may be configured to require additional authentication, shown in FIG. 2 at optional step 110, which is indicated as an optional step in FIG. 2 by dashed lines. At optional step 110, the user may be required to authenticate the user or the mobile user device 20, for example, by inputting one or more of a PIN, OTP, challenge response, transaction identifier and/or other authentication value to the mobile user device 20 to prompt the ATM application 22 to transmit authentication information to the provider's authentication system. The authentication information transmitted at step 110 may be, for example, one or more of a PIN, authentication information inputted in step 104, a machine identifier unique to user device 20, a value provided by a DVG 26 on the mobile user device 20, which may be an OTP or one-time transaction identifier generated using a key, and/or secret shared by the mobile user device 20 and the provider authentication system, for example, and shared with authentication server 66 of provider B system 60 for an ATM transaction related to the user's provider B account. The authentication information inputted at step 110 may be inputted through interfaces 23, 33, or may be inputted directly into the ATM 30 through the ATM keypad 35, a display touch screen 34 or another ATM input interface. It would be understood that the optional step 110 may occur at another point in the sequence of the method 100. For example, the optional step 110 may occur between step 106 and step 108, where the ATM system may require authentication before the ATM 30 is activated to receive transaction information from the mobile user device 20. Alternatively, the optional step 110 may occur after step 112 where the provider system may require authentication information to be input during the transaction authorization process.

Continuing with step 112, as shown on FIG. 2, the ATM 30 may connect to the provider system associated with the user's requested ATM transaction through the interface 31 and through typically, either network 40 or through a host server or system 50. For illustration and by way of example, at step 112, the ATM 30 may connect to the provider B system 60 via the interface 31, the network 40 and the interface 61. Alternatively, the ATM 30 may connect to the provider B system 60 through the provider A system, where the provider A system may be a host system for the ATM 30, via the interfaces 31, 51, 61 and the network 40.

At step 114, in the present example, the provider B system 60 receives the inputted transaction information, which may include the authentication information as described previously, from the ATM 30. The provider B system 60 processes the transaction request through a transaction authorization system 62. The transaction authorization system 62 may, for illustrative example, verify the user's provider B account information, confirm sufficient funds availability in the user's provider B account to complete the requested transaction, communicate with an authentication system 66 to determine validation of the user's authentication information, check for security alerts on the user's account which may require additional user input or validation to authorize the transaction, and generate a transaction authorization result. Step 114 may further include, during authentication validation, generation of a dynamic value by the authentication server 66 in the present example, using a key or secret and algorithm shared with a DVG 26 on the mobile user device 20, and matching the value generated by the authentication server 66 to the value inputted with the transaction information as a requirement to authorize the transaction. The authentication system 66 provides the authentication result to transaction the authorization system 62 as part of the transaction authorization result.

At step 116, the transaction authorization system 62, in the present example, provides a transaction authorization result to the ATM 30. The transaction authorization result is based upon the authorization and authentication criteria of the provider, in this example, the provider B. For example, upon verification of the user's provider B account information, sufficiency of funds to complete the transaction and positive validation of the inputted authentication information, the provider B system 60 provides an affirmative transaction authorization result to the ATM 30, and at step 118 the ATM 30 completes the requested transaction. Completing the requested transaction may include, for example, one or more of transferring funds from one account to another, completing a payment transaction, completing a funds withdrawal which may include dispensing funds from the funds dispenser 42 of the ATM 30 in a negotiable form, which may be, for example, money, cash, coin, currency or other medium such as a debit or gift card, a mobile wallet or another mobile payment mechanism, transferring funds to a third party, authorizing a beneficiary transaction, etc. As an alternative, and by way of example, if the inputted information cannot be verified and validated by the provider B system 60, or the user's account data indicates insufficient funds to complete the requested transaction, the provider B system 60 in the present example would provide a negative transaction authorization result to the ATM 30, and at step 118 the ATM 30 completes the sequence by declining the requested transaction.

The method of FIG. 2 may include an optional step 120 (indicated as optional by the dashed lines of step 120), where optionally a transaction record is provided by the ATM 30. The transaction record may include any element or combination of elements of information typically found on a transaction record, such as the transaction date, the transaction time, an account identifier, a transaction amount, an account balance, a transaction identifier, a confirmation number, an ATM identifier, an ATM location, etc. The transaction record is preferably provided in a paperless form, or may also be provided in printed form, for example, as a printed receipt produced by the ATM 30 and dispensed to the user, or as a printed receipt mailed to the user. The transaction record may be provided in paperless form directly to the mobile user device 20 through the connection interface between the ATM 30 and the mobile user device 20, or may be provided through another means, for example, from the provider system through the network 40 to the user or to the mobile user device 20 as an short message service (SMS), text message or email. The ATM application 22 on the mobile user device 20 may store all or part of the transaction record provided to provide the user with a convenient reference and record of recent transactions retrievable from the mobile user device 20. Finally, at step 122, the mobile user device 20 is disconnected from the ATM 30 and the ATM transaction session is ended. The user may be required to prompt the ATM 30 and/or the mobile user device 20 to disconnect, for example, by selecting a “disconnect” option from a menu on the ATM 30 or the mobile user device 20, or in the case of a wired connection, for example, disconnecting the USBs of ATM 30 and the mobile user device 20.

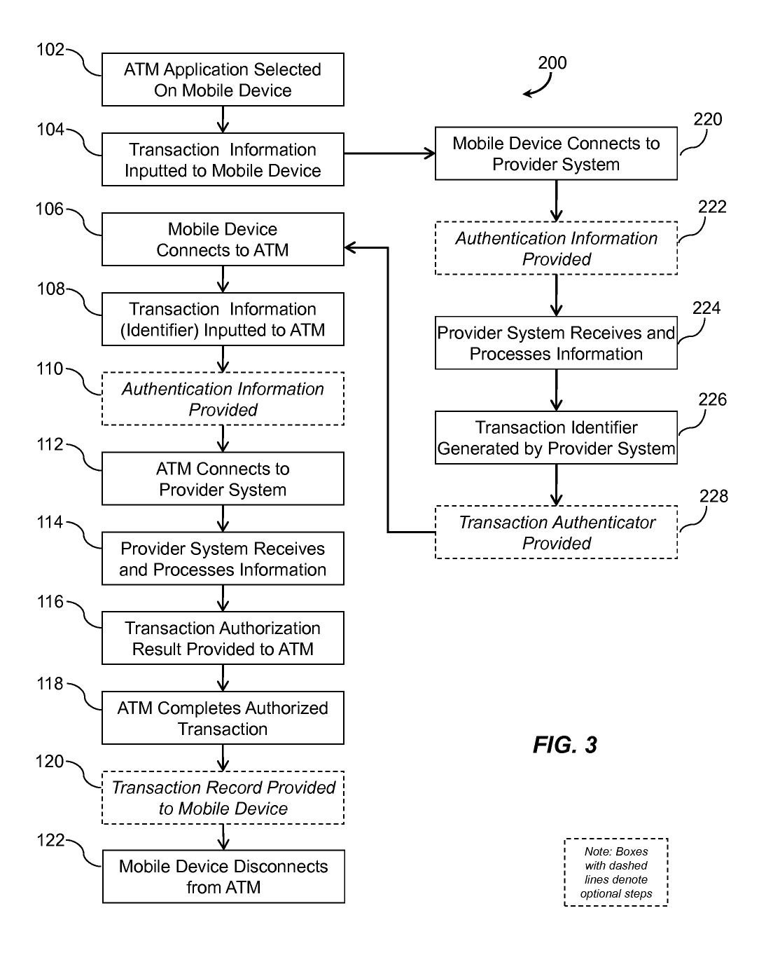

Referring now to FIG. 3, shown generally at 200 is a schematic illustration of a process for performing an ATM transaction using a mobile device in communication with a provider system and an ATM. The method shown generally at 200 provides additional security advantages to the user by generating or providing a transaction identifier for all or a portion of the transaction information inputted by the user or mobile user device 20 into ATM 30. By substituting a transaction identifier for transaction information, interception attacks which may occur within the ATM system including attacks on ATM interfaces 33 and 31, keypad 35, display 34, or card reader 39 may be thwarted by yielding a transaction identifier to the attacker which does not reveal transaction details to the attacker. Further, the transaction identifier may be encrypted, obfuscated or camouflaged using a key, and/or secret shared by the user's mobile user device 20 and the provider system of the provider with which the transaction is to be conducted, such that the transaction identifier is not discernible by any system other than the provider system.

Referring to FIG. 3, referencing FIG. 1 and beginning with step 102, a user accesses an ATM application 22 on the user's mobile user device 20. As described for FIG. 2, the user may have previously been required to download the ATM application 22 to the mobile user device 20 and additionally, the user may have been required to activate each provider and/or provider account on the ATM application 22 prior to using the ATM application 22 to perform an ATM transaction related to the specific provider or provider account. As described for FIG. 2, the user may also be required, prior to step 102, to download and install a DVG 26 to the mobile user device 20, where the DVG 26 is configured to provide an authenticating value or transaction identifier or both.

In one configuration, the DVG 26 may be downloaded with or as part of the ATM application 22, and may include one or more algorithms which may be configured to generate one-time passcodes or other one-time values related to one or more providers, using a key, secret or other datum which may be proprietary to one or more of the providers with which the user plans to conduct ATM transactions. In another configuration, the DVG 26 may be downloaded to the mobile user device 20 during a provider activation sequence and may include an algorithm which is proprietary to that provider, and configured to generate one-time values using a key, secret or other datum also proprietary to that provider. In either configuration, the key or secret shared between the mobile user device 20 and the user's provider system may be provided to the mobile user device 20 in any suitable manner, e.g., during activation of the provider on the ATM application 22, during download of the provider's algorithm, or subsequently through another online session, through an email, SMS or other suitable means.

Returning to FIG. 3, at step 104, the user selects a provider and a provider ATM transaction to be completed using the mobile user device 20 and inputs the transaction information into the mobile device, as described previously for FIG. 2. Using an illustrative example, the user may choose to conduct a withdrawal from the user's savings account with the provider A. At step 104, the user selects the provider A using the ATM application 22, from, for example, a menu associated with the ATM application 22, and similarly selects from the menu the user's savings account with the provider A and a transaction of “funds withdrawal” or similar. The user enters into the mobile user device 20 the amount of the funds withdrawal being requested and other information as described for step 104 related to FIG. 2.

The process continues from step 104 to step 220. At step 220, the user connects the mobile user device 20 to the provider system with which the user is conducting the transaction or transactions, which in the illustrative example, is the provider A system 50. In the present example, the mobile user device 20 is connected to the provider A system 50 via the network 40 using the device interface 21 and the provider A interface 51. The user may be required to prompt the mobile user device 20 to connect with the provider system A, for example, by selecting a “Connect to Provider System” option from a menu on the mobile user device 20 or otherwise initiating a network session between the mobile user device 20 and the provider A system 50.

Optionally, the provider system, in this example, the provider system A, may be configured to require additional authentication, shown in FIG. 3 at step 222, which is indicated as an optional step by dashed lines. At optional step 222, the user may be required to authenticate the user and/or mobile user device 20, for example, by providing one or more of a PIN, OTP, challenge response and/or other authentication value to the provider A system 50 from the mobile user device 20. The authentication information transmitted at step 222 may include, for example, a PIN, authentication information inputted in step 104, a machine identifier unique to the mobile user device 20, a value provided by DVG 26 on the mobile user device 20 which may be an OTP or one-time transaction identifier generated using a key or secret shared by the mobile user device 20 and the provider authentication system, in the illustrative example, shared with the authentication server 56 of the provider A system 50 for the user's provider A account. The authentication information inputted at step 222 may be inputted through a mobile user device input interface such as a keypad 25 or a display touch screen 24, or may be generated by the mobile user device 20, for example, by a DVG 26, and provided through a device interface 21 through the network 40 to the provider A interface 51. It would be understood that the optional step 222 may occur at another point in the sequence of the method 200. For example, the optional step 222 may occur between step 224 and step 226, where the provider system may require authentication information to be input during transaction processing.

At step 224 of FIG. 3, the provider system receives the transaction information provided by the mobile user device 20, which may include authentication information. The provider system, in this example, the provider A system 50, may process the transaction request through a transaction authorization system 52. The authorization system 52 may, for the illustrative example, verify the user's provider A account information, confirm sufficient funds availability in the user's account to complete the requested transaction, communicate with authentication system 56 to determine validation of the user's authentication information, check for security alerts on the user's account which may require additional user input or validation to authorize the transaction, and generate a transaction authorization result. Further, at step 224, the transaction authorization system 56 may determine a transaction authorization result. As described for FIG. 2, the transaction authorization result may be based upon the authorization and authentication criteria of the provider, which in this example is the provider A. For example, upon verification of the user's provider A account information, sufficiency of funds to complete the transaction and positive validation of the inputted authentication information, the provider A system 50 may produce an affirmative transaction authorization. As an alternative, and by way of example, if the inputted information cannot be verified and validated by the provider A system 50, or the user's account data indicates insufficient funds to complete the requested transaction, the provider A system 50 in the present example, may produce a negative transaction authorization result.

Continuing with FIG. 3 and step 224, the transaction authorization result may be provided to the user through the mobile user device 20. The transaction authorization result may be of the same format provided in step 116 to the ATM 30 the user interfaces with to complete the transaction, or may be in a different format. For example, the transaction authorization may be provided in human readable characters in a message displayed by the application 22 on the display 24 of the mobile user device 20, where the message displayed may be “Authorized” or “Approved” or similar for an affirmative transaction authorization or “Not Authorized” or “Declined” or similar for a negative transaction authorization result. Alternatively, the transaction authorization result may be provided to the user only if the transaction is declined. In either configuration, the user is provided the additional advantage and convenience of determining whether the transaction will be authorized prior to proceeding to the ATM.

After the user's requested transaction has been affirmatively authorized at step 224, the provider system at step 226 may generate a transaction identifier, which may be specific to the user's authorized transaction. The transaction identifier generated or provided may serve as a substitutional value for the transaction information which the mobile user device 20 would input to the ATM, for example, in step 108 of process 200, and may further serve as a substituted or substitutional value for authentication or authorization information. Accordingly, the transaction identifier provided at step 226 is preferably unique to the user's authorized transaction, or may when inputted with an associated authenticator or authenticating value, such as a challenge or PIN, provide or generate a unique identifying parameter associated with the authorized transaction. The transaction identifier may be configured as one of or a combination of a character string of one or more alpha-numeric or special characters, a datum or an electronic signal transmittable from the user device, a datum or an electronic signal generated by the user device, or as a user instruction. These examples are not intended to be limiting in scope, and it is understood that a transaction identifier could be configured in any form which may be input into an ATM interface by, for example, the user or user device. For example, the transaction identifier may be an electronic signal or data transmittable from the mobile user device 20 to the ATM 30 through a connection which may be established between the interfaces 23, 33. As another example, the transaction identifier may be provided in human readable characters which can be input into the ATM 30 through an ATM input interface such as the keypad 35 or a touch screen display 34.

The transaction identifier generated by the provider system at step 226 may be further secured, for example, by any method of encryption, obfuscation, camouflaging or other cryptographic or data security technique. The method of encryption, obfuscation, camouflaging or other cryptographic or data security technique may employ or incorporate a key or secret which is shared between the authorizing and authenticating systems of the transaction provider, such that the provider system may use the shared secret to decrypt the transaction identifier provided by the mobile user device 20 to the ATM 30 to the provider system when the user completes the transaction at the ATM 30. In another configuration, the key or secret may be shared between the provider system and the mobile user device 20, such that the mobile user device 20 can encrypt the transaction identifier, for example, using a DVG 26, prior to input of the transaction identifier into the ATM 30 at step 108 of FIG. 3, such that encrypted transaction identifier may only be processed by the provider system sharing the key or secret used by the DVG 26. As described previously, this provides an additional layer of security to the user in the event the security of one or more of the ATM 30 interfaces, including the interface 33, have been breached by an attacker using, for example, a skimming, wiping or other type of data intercepting attack.

The transaction identifier generated and provided at step 226 may be further configured or restricted in accordance with a provider policy or user account settings, to be redeemable at an ATM within a limited geographical area or time period, beyond which the transaction identifier becomes invalidated or expired.

At an optional step 228 of FIG. 3, which is indicated as an optional step by dashed lines, the process 200 may be configured to include generating or providing a transaction authenticator associated with the transaction identifier provided at step 226. The transaction authenticator may be configured as one of or a combination of a character string of one or more alpha-numeric or special characters, a datum or an electronic signal transmittable from the user device, a datum or an electronic signal generated by the user device, or as a user instruction. These examples are not intended to be limiting in scope, and it is understood that a transaction identifier could be configured in any form which may be input into any ATM interface by, for example, the user or the mobile user device 20. The transaction authenticator may be a PIN, challenge, OTP or a dynamic value provided to the user or user device by any suitable means. For example, the transaction authenticator may be a PIN or challenge generated by the provider system and provided to the mobile user device 20 as a SMS text message, voice mail, email or other means. The transaction authenticator may be a dynamic value generated, for example, using a key or secret and algorithm shared with a DVG 26 on the mobile user device 20 and the provider system 50, in the present example. The transaction authenticator may be an instruction to the user, for example, to generate an authenticator value using a DVG 26 on the mobile user device 20, or to input to the ATM 30, through a device 20 keypad or directly, the amount of the transaction for use as an authenticating value.

Referring again to FIG. 3, the user, at step 106, may connect the mobile user device 20 to the ATM 30 as described for the method and process of FIG. 2.

At step 108, the transaction information, which for the process 200 shown in FIG. 3 may be the transaction identifier provided in step 226, is communicated from the mobile user device 20 to the ATM 30 through the interfaces 23, 33. In a preferred embodiment, the transaction identifier is representative of and substituted for all information required to complete the user's ATM transaction, including, for example, authentication information, thus avoiding the need for the user to input any information into the ATM 30 through the ATM keypad 35, a display touch screen 34, and/or a card reader 39.

Alternatively, the provider system may be configured to require additional authentication, shown in FIG. 3 at step 110, which is indicated as an optional step by dashed lines. At the optional step 110, the user may be required to provide authentication information as described for FIG. 3. Additionally or alternatively, the user may be required at the optional step 110 to input or provide the transaction authenticator which was generated at step 228 of the method 200. The authentication information inputted at step 110 may be inputted through the interfaces 23, 33, or may be inputted into the ATM 30 through an ATM keypad 35, a display touch screen 34 and/or other ATM input interface. It would be understood that the optional step 110 may occur at another point in the sequence of the method 100. For example, the optional step 110 may occur between step 106 and step 108, where the ATM system may require authentication before the ATM 30 is activated to receive transaction information from the mobile user device 20. Alternatively, the optional step 110 may occur after step 112 where the provider system may require authentication information to be input during the transaction authorization process.

Continuing with step 112, as shown on FIG. 3, the ATM 30 connects to the provider system associated with the user's requested ATM transaction through an interface 31 and typically, through either the network 40 or through a host server or system 50. For illustration and by way of example, at step 112, the ATM 30 may connect to provider A system 50 via the interface 31, the network 40 and the interface 51.

At step 114, the provider A system 50 receives the inputted transaction identifier, and if required by the optional step 110, the inputted authentication information, from the ATM 30, and may process the transaction request through a transaction authorization system 52. In a first embodiment of step 114, the transaction authorization system 52 may be configured to verify the user's transaction identifier generated in step 224 and provided to the ATM 30 from the mobile user device 20 in step 108, and upon verification, may provide a transaction authorization result to the ATM 30 at step 116. Verifying the user's transaction identifier may further include validating the transaction authenticator generated in step 228 and provided to the ATM 30 in optional step 110.

In a second embodiment of step 114, the provider system, in this example, the provider system A, receives the transaction identifier generated in step 226 and provided by the user to the ATM 30 in step 108, and associates the transaction identifier with the transaction request information. The transaction request information may include one or more of the user's account information, requested transaction type and amount, authentication information or other information inputted by the user in step 220 and optionally, step 222 and used to generate the transaction identifier. Associating the transaction identifier with the user's transaction request information may further include associating the identifier with transaction request information from the provider system database, decrypting or otherwise transforming the transaction identifier to a value discernable by the transaction authorization system, which may further include retrieving or generating a key or secret shared with the user or the mobile user device 20, authenticating a PIN, challenge, OTP or other authenticator provided by the user through ATM 30 at steps 108 and optionally 110. The provider authorization system 52 then may verify the user's transaction request in step 114 as described for FIG. 2, and may generate a transaction authorization result.

At step 116, the transaction authorization system may provide the transaction authorization result to the ATM 30, as previously described for FIG. 2. At step 118 the ATM 30 may complete the authorized transaction, again as previously described for FIG. 2, where the authorized transaction is one of completing or declining the requested transaction in accordance with the transaction authorization result provided to the ATM 30 in step 116. In step 118, the ATM 30 may complete the requested transaction when the ATM 30 has received an affirmative transaction authorization result during step 116. Otherwise, in step 118, the ATM 30 may decline the requested transaction when the ATM 30 has received a negative transaction authorization result during step 116.

As previously described for FIG. 2, the method of FIG. 3 may include an optional step 120 (indicated as optional by the dashed lines of step 120), where optionally a transaction record may be provided by the ATM 30 to the user. Finally, at step 122, the mobile user device 20 may be disconnected from the ATM 30 and/or the ATM transaction session.

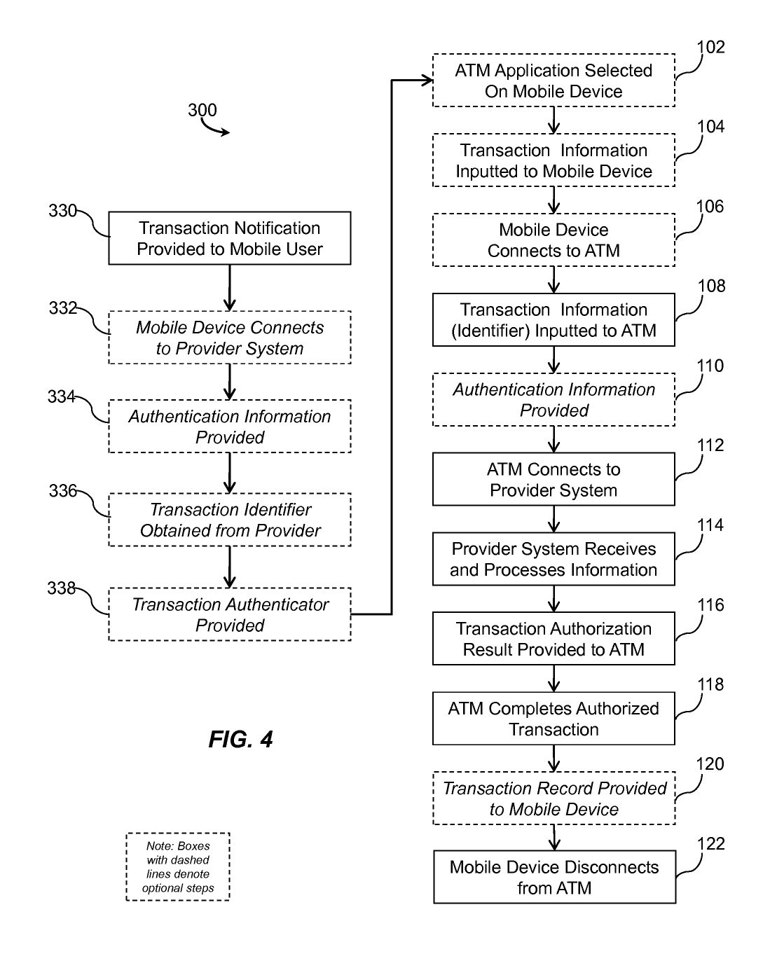

Referring now to FIG. 4, shown generally at 300 is a schematic illustration of a process for performing a beneficiary transaction using a transaction beneficiary's mobile device in communication with an ATM 30 or network 40. As referred to herein, a beneficiary transaction or third-party transaction is used to generally describe a transaction which occurs for to the benefit of a user other than the provider account holder. For example, a beneficiary transaction may be a wire transfer to a beneficiary who is not a holder of the provider account from which the funds are being withdrawn for transfer or disbursement to the beneficiary. Referencing FIGS. 1 and 4, in an example scenario the beneficiary user is in possession of a mobile user device 20 which is configured to communicate with the network 40. As shown in step 330, the beneficiary user may receive a transaction notification that a transaction request has been executed on behalf of, or for the benefit of the beneficiary user.

In a non-limiting example, the beneficiary user may receive the transaction notification on the beneficiary user's mobile user device 20. The transaction notification may be configured as an SMS text message, a voice mail, an email, or may be in any configuration suitable for receipt on the mobile user device 20. Alternatively, the transaction notification may be received by the beneficiary as a paper document by mail or in person, via a phone call, via a notification during an online transaction which may be recorded or downloaded, or any configuration suitable for communicating the transaction notification to a beneficiary user. The transaction notification provided in step 330 may be in any format, and may include any information suitable to or as required by the provider from which the transaction request has been made.

In a first embodiment or example, the transaction notification may be provided as a transaction identifier, such as the transaction identifier generated in step 226 shown on FIG. 3, where the transaction identifier is provided to the beneficiary user's mobile user device 20 as one of an SMS text message or an email. As described for FIG. 3, the transaction identifier may be configured as one of or a combination of a character string of one or more alpha-numeric or special characters, a datum or an electronic signal transmittable from the user device, a datum or an electronic signal generated by the user device, or as a user instruction. These examples are not intended to be limiting in scope, and it is understood that a transaction identifier could be configured in any form which may be input into any ATM interface by, for example, the user or the mobile user device 20. The transaction identifier may also include an identifier of the provider system associated with the transaction. Further, the transaction identifier, as described for FIG. 3, may be secured, for example, by any method of encryption, obfuscation, camouflaging or other cryptographic or data security technique. The beneficiary user obtains or retrieves the transaction identifier and may download or save the transaction identifier to the mobile user device 20 prior to proceeding to an ATM, which may be, for example, the ATM 30 of FIG. 1.

In the first embodiment shown in FIG. 4, after completing step 330, the process may continue at step 108, by bypassing optional steps 332-338 and optional steps 102-106 (indicated as optional by dashed lines). At step 108, the beneficiary user proceeds to ATM 30 to input the transaction identifier using the ATM interface suitable for the format of the transaction identifier. The beneficiary user may be required to first select the requested transaction from a menu of the ATM 30, for example, the beneficiary user may select a menu item, such as “redeem transaction identifier” or, “complete third party transaction,” or similar. Continuing with step 108, the beneficiary user inputs the transaction identifier to the ATM 30 through an interface compatible with the format of the transaction identifier. For example, the user may input the transaction identifier manually through a keypad 35 or through a touch screen 34, or may transmit the transaction identifier from the mobile user device 20 through an interface 23 to an interface 33, which may be, for example, any form of contact or contactless interfaces which can be configured to enable communication between the mobile user device 20 and the ATM 30, as previously described.

In the first embodiment shown in FIG. 4, the process may bypass the optional step 110 and proceed to step 112, where the ATM 30 may connect to the provider system from which the beneficiary transaction was requested or with which the transaction is associated. As noted previously, the transaction identifier may include a provider identifier which enables the ATM 30 to identify the provider system associated with the transaction identifier and transaction request. Alternatively, the user may be required to select the provider system from an ATM menu. In this event, the user will have received information identifying the provider system with the transaction notification or subsequent to receiving the transaction notification.

Continuing with step 112, as shown on FIG. 4, the ATM 30 may connect to the provider system associated with the user's requested ATM transaction as described for FIG. 3, and at step 114, the provider system may receive the inputted transaction identifier. The provider system, at step 114, may process the transaction identifier through a transaction authorization system 52 and/or authentication system 56, for example, where the provider A system 50 is associated with the transaction, by verifying the transaction identifier as an authentic transaction identifier. Verifying the transaction identifier may include decrypting or otherwise transforming the transaction identifier to a value discernable by the transaction authorization system, determining whether the transaction identifier has been previously redeemed, determining whether the transaction identifier is being redeemed within any limitations established for the transaction identifier, such as an expiration date/time or authorized geographic area, determining whether any security or other alerts apply to the transaction identifier, and verifying available funds in the provider account from which the transaction is to be redeemed.

Following processing of the transaction identifier, the provider system may provide a transaction authorization result to the ATM 30 at step 116, as previously described for FIG. 2. At step 118 the ATM 30 may complete the authorized transaction, again as previously described for FIG. 2, where the authorized transaction is one of completing or declining the requested transaction in accordance with the transaction authorization result provided to the ATM 30 in step 116. In step 118, the ATM 30 may complete the requested transaction when the ATM 30 has received an affirmative transaction authorization result during step 116. Otherwise, in step 118, the ATM 30 may decline the requested transaction when the ATM 30 has received a negative transaction authorization result during step 116.

As previously described with reference to FIG. 2, the method of FIG. 3 may include an optional step 120 (indicated as optional by the dashed lines of step 120), where a transaction record may be provided by the ATM 30, and may include an optional step 122, where the mobile user device 20 is disconnected from the ATM 30.

In a second embodiment, referring again to FIG. 4 and method 300, at step 330, the beneficiary user may also receive authentication information, which may be included with the transaction notification or which may be sent separately to the beneficiary user. The beneficiary user may receive the authentication information on the beneficiary user's mobile user device 20. The authentication information may be provided via an SMS text message, a voice mail, an email or may be in any configuration suitable for receipt on the mobile user device 20. Alternatively, the authentication information may be received by the beneficiary as a paper document by mail or in person, via a phone call, or as information received during an online transaction which may be recorded or downloaded, or any configuration suitable for communicating the authentication information to a beneficiary user.

The authentication information provided in step 330 may be in any format, and may include any information suitable to or as required by the provider from which the transaction request has been made. For example, the authentication information may be a PIN, OTP or other dynamic value, or a challenge which may include information known only by the provider system and provided to the beneficiary user. As described previously, the authentication information may be configured as one of or a combination of a character string of one or more alpha-numeric or special characters, a datum or an electronic signal transmittable from the user device, a datum or an electronic signal generated by the user device, or as a user instruction or challenge. These examples are not intended to be limiting in scope, and it is understood that the authentication information could be configured in any form which may be input into any ATM interface by, for example, the user or the mobile user device 20. Further, the authentication information, as previously described, may be secured, for example, by any method of encryption, obfuscation, camouflaging or other cryptographic or data security technique.

The beneficiary user obtains or retrieves the authentication information at step 330 and may download or save the authentication information to beneficiary user's mobile user device 20 prior to proceeding to an ATM, which may be, for example, ATM 30 of FIG. 1. The process may continue at step 108, by bypassing optional steps 332-338 and optional steps 102-106 (indicated as optional by dashed lines). Continuing at step 108, the beneficiary user may proceed to the ATM 30 and may input the transaction identifier into the ATM 30 as described for the first configuration of FIG. 4. In a second embodiment of FIG. 4, at step 110, the beneficiary user may provide authentication information to the ATM 30 through an interface compatible with the authentication information format. For example, the user may input the authentication information manually through a keypad 35 or through a touch screen 34, or may transmit the authentication information from the mobile user device 20 through an interface 23 to an interface 33, which may be, for example, any form of contact or contactless interfaces which may be configured to enable communication between the mobile user device 20 and the ATM 30, as previously described.

Continuing with step 112, as shown on FIG. 4, the ATM 30 connects to the provider system associated with the user's requested ATM transaction as described for FIG. 3, and at step 114, the provider system receives the inputted transaction identifier and authentication information, which is collectively the transaction information. The provider system, at step 114, may process the transaction identifier and authentication information through a transaction authorization system 52 and/or an authentication system 56, as previously described for FIGS. 2 and 3. The ATM 30 may complete the authorized transaction through steps 116-120, again as previously described for FIGS. 2 and 3.

Still referring to FIG. 4, in a third embodiment or example, the beneficiary user, at step 330 may receive a transaction notification as described previously. The beneficiary user may also, at step 330 and as described previously, receive authentication information. Referring now to step 332, the transaction notification may include instructions or a link for the beneficiary user to connect the beneficiary user's mobile user device 20 to the provider system, for example, through an interface 21 of the mobile user device 20 and the provider system interface (one of 51, 61, 71 for example) of the provider system associated with the beneficiary transaction. The beneficiary user may be required, at step 334, to input authentication information associated with the beneficiary transaction to the provider interface.

In a next step 336, the provider system may provide to the mobile user device 20 a transaction identifier. The provider system may verify the authentication information provided by the beneficiary user prior to providing the transaction identifier, or may require other authenticating information, such as the beneficiary's identity or identifying information or a challenge response prior to providing the transaction identifier at step 336.

Continuing at step 338, the provider system may also provide a transaction authenticator to the mobile user device 20, as described previously for FIG. 3. The transaction authenticator may include a dynamic value generator 26, which may be used with the authentication information or a secret or key shared with the provider system to generate the transaction identifier or another value, such as an OTP for use in authenticating the beneficiary transaction. As would be understood, steps 332 through 336 may be reordered accordingly for a specific provider system requirement or preference.

The method 300 of FIG. 4 may proceed from step 336 to step 108, and as described previously for the second embodiment of FIG. 4, the user may complete steps 108-120 to complete the transaction. As shown in step 102 and previously described for FIG. 2, the beneficiary user may also be required to download an ATM application 22 to the user device 20. In this event, the beneficiary user may be required to select the ATM application 22 in step 102, and proceed through steps 102-122 as described for FIGS. 2 and 3.

It would be understood that other variations are possible by combining the elements of the system and methods described herein. For example, other variations may include methods and systems wherein a portion of the transaction information is inputted to the ATM using typically or currently known methods such as the keypad or touch screen, or duplicate entry of authentication information from the user's mobile device and through another ATM input may be required as an additional method of multi-factor authentication.

Those having ordinary skill in the art will recognize that terms such as “encrypt,” “obfuscate,” “key,” “PIN,” “OTP,” “ATM,” “server,” “website,” “code,” “challenge,” “authenticate,” “identifier,” etc., are used descriptively of the figures, and do not represent limitations on the scope of the invention where other terms may be used in a generally equivalently descriptive manner.

While the best modes for carrying out the invention have been described in detail, those familiar with the art to which this invention relates will recognize various alternative designs and embodiments for practicing the invention within the scope of the appended claims.

1. A system for conducting an automatic teller machine (ATM) transaction with a provider system, comprising:
a provider system configured to communicate with an ATM, a network, and a mobile user device;
wherein the mobile user device is configured to communicate with one or more of the network, the ATM and the provider system, and is configured to receive transaction information related to an ATM transaction between the provider system and a user of the mobile user device; and
wherein the ATM is configured to receive the transaction information provided to the mobile user device such that the ATM and the provider system can process the ATM transaction when the transaction information is input into the ATM.

2. The system of claim 1, wherein:
the ATM includes an ATM interface;
the mobile user device includes a mobile user device interface; and
the ATM interface is configured to receive transaction information from and send transaction information to the mobile user device interface; and
the mobile user device interface is configured to receive transaction information from and send transaction information to the ATM interface.

3. The system of claim 2, wherein the ATM interface and the mobile user device interface are each configured as one of a contact and a contactless interface.

4. The system of claim 1, wherein the transaction information includes at least one of a provider identifier, a user identifier, an account identifier, a transaction identifier, a transaction type, a transaction amount, a transaction limitation, an expiration value, an authentication value, a passcode, a personal identification number, a beneficiary identifier, identification information, transaction data, authentication information, a challenge, a challenge response, a digital signature, a key, a secret, a datum, a device identifier, a biometric value, an instruction, a provider link, an authentication result, an authenticator, and an authorization result.

5. The system of claim 1, wherein a transaction identifier is substituted for at least a portion of the transaction information provided to the ATM.

6. The system of claim 1, further comprising:
a dynamic value generator including an algorithm; and
a key configured for use with the algorithm;
wherein:
the key and the algorithm are shared by the provider system and the mobile user device;
the provider system and mobile user device are each configured to generate a dynamic value using the dynamic value generator and the key; and
the generated dynamic value is provided to the ATM such that a user of the mobile user device can complete the ATM transaction with the provider system.

7. The system of claim 6, wherein the dynamic value represents at least a portion of the transaction information, including at least one of a transaction identifier, a passcode, an authentication value and a challenge response.

8. The system of claim 1, further comprising:
an ATM application configured to receive and send transaction information related to the ATM transaction between the mobile user device and at least one of the ATM and the provider system.

9. The system of claim 8,
wherein the ATM application includes a dynamic value generator configured to generate a dynamic value using a key shared by the ATM application and the provider system; and
wherein the dynamic value represents at least a portion of the transaction information, including at least one of a transaction identifier, a passcode, an authentication value and a challenge response.

10. The system of claim 1, wherein the mobile user device is a beneficiary user device, and wherein the transaction information is beneficiary transaction information provided to the beneficiary user device by the provider system such that the ATM and the provider system can process the beneficiary user ATM transaction when the beneficiary transaction information is inputted into the ATM.

11. A method for conducting an automatic teller machine (ATM) transaction with a provider system, the method comprising:
inputting transaction information into a mobile user device;
establishing a connection between the mobile user device and an ATM;
inputting the transaction information into the ATM via the connection established between the mobile user device and the ATM;
providing the transaction information to a provider system using the ATM;
processing the transaction information using the provider system;
generating and providing a transaction authorization result to the ATM using the provider system; and
completing the authorized transaction using the ATM.

12. The method of claim 11, wherein the transaction information includes at least one of a provider identifier, a user identifier, an account identifier, a transaction identifier, a transaction type, a transaction amount, a transaction limitation, an expiration value, an authentication value, a passcode, a personal identification number, a beneficiary identifier, identification information, transaction data, authentication information, a challenge, a challenge response, a digital signature, a key, a secret, a datum, a device identifier, a biometric value, an instruction, a provider link, an authentication result, an authenticator, and an authorization result.

13. The method of claim 11, wherein establishing a connection between the mobile user device and the ATM includes:
connecting a mobile user device interface to an ATM interface;
wherein the ATM interface is configured to receive transaction information from and send transaction information to the mobile user device interface; and
wherein the mobile user device interface is configured to receive transaction information from and send transaction information to the ATM interface.

14. The method of claim 13, wherein the ATM interface and the mobile user device interface are each one of a contact and a contactless interface.

15. The method of claim 11, wherein inputting transaction information into the mobile user device includes:
installing an ATM application on the mobile user device;
activating the ATM application to communicate with the provider system; and
inputting transaction information into the ATM application.

16. The method of claim 15, wherein installing the ATM application on the mobile user device includes:
installing a dynamic value generator configured to generate a dynamic value using a key shared by the ATM application and the provider system, wherein the dynamic value represents at least a portion of the transaction information, including at least one of a transaction identifier, a passcode, an authentication value and a challenge response.

17. The method of claim 11, wherein inputting transaction information into the mobile user device includes:
establishing a connection between the mobile user device and the provider system;
providing the transaction information to the provider system via the connection between the mobile user device and the provider system; and
generating and providing a transaction identifier to the mobile user device using the provider system; and
wherein inputting the transaction information into the ATM via the connection between the mobile user device and the ATM includes:
inputting the transaction identifier;
wherein the transaction identifier that is inputted is substituted for at least a portion of the transaction information.

18. The method of claim 17, further comprising:
generating and providing a transaction authenticator to the mobile user device using the provider system; and
inputting authentication information into the ATM via the connection between the mobile user device and the ATM using the transaction authenticator.

19. The method of claim 11,
wherein inputting transaction information into the mobile user device includes:
providing a transaction notification to a beneficiary user device using the provider system;
establishing a connection between the beneficiary user device and the provider system; and
receiving beneficiary transaction information from the provider system via the connection between the beneficiary user device and the provider system; and
wherein inputting the transaction information into the ATM via the connection between the mobile user device and the ATM includes:
inputting the beneficiary transaction information using the beneficiary user device, including inputting a beneficiary transaction identifier in substitution for all or a portion of the transaction information.

20. The method of claim 19, further comprising:
generating and providing a transaction authenticator to the beneficiary user device using the provider system; and
inputting authentication information into the ATM via the connection between the mobile user device and the ATM using the transaction authenticator.
